(19) United States
(12) Patent Application Publication
(10) Pub. No.: US 2023/0126546 A1
(43) Pub. Date: Apr. 27, 2023

(54) GAS LEAK ESTIMATION

(71) Applicant: Baker Hughes Holdings LLC, Houston, TX (US)

(72) Inventors: Arjun Roy, Katy, TX (US); Sangeeta Nundy, Denver, CO (US); Bhasker Rao Keely, Bangalore (IN); Ammar Mohammed Abdilghanie Mohammed, Aurora, IL (US); Rosa Swartwout, Tucson, AZ (US)

(21) Appl. No.: 17/964,398

(22) Filed: Oct. 12, 2022

Related U.S. Application Data
(60) Provisional application No. 63/270,870, filed on Oct. 22, 2021.

(51) Int. Cl. G01M 3/38

(52) U.S. Cl. CPC G01M 3/38

(57) ABSTRACT

Data characterizing a first set of locations of a plurality of sensors at an industrial site is received. Gas concentration, wind velocity at the industrial site, and an identified leakage area at the industrial site are detected by the plurality of sensors. Locations and leakage rates of one or more leakage sources is determined in the identified leakage area by a predictive dispersion model. The predictive dispersion model is configured to receive the wind velocity at the industrial site and the locations and leakage rates of the one or more potential leakage sources as input and generate the set of estimated gas concentration as output. A comparative metric based on the set of estimated gas concentrations is compared to the detected gas concentrations. The selected location and leakage rates of the potential leakage sources in a current iteration of the iterative determination are provided.

### RELATED APPLICATION

This application claims priority under 35 U.S.C. § 119(e) to U.S. Provisional Patent Application No. 63/270,870 filed on Oct. 22, 2021, the entire content of which is hereby expressly incorporated by reference herein.

### BACKGROUND

Monitoring and detection of gas leaks is commonly performed by inspection of industrial assets, such as assets configured in gas production and distribution environment, mining and bio-gas industries, waste-water treatment plants, and other environments. Inspections can be performed to ensure operational safety of the assets and to determine the presence of leaks or gas emissions which can be emanating from an emission source. Gas leaks in these environments can create hazardous operating conditions for personnel assigned to operate, maintain, and repair the industrial assets and can reduce production rates. Gas leaks can occur as a result of equipment failures which can cause the release of unplanned, or fugitive gaseous emission. Gas leaks can also occur as a result of venting that is part of the normal and expected operation of the equipment or assets. Localized weather patterns can alter the concentration, location, and distribution of the gas emission making it difficult to accurately determine an emission source associated with the gas leak.

### SUMMARY

In one aspect, a method includes receiving data characterizing a first set of locations of a plurality of sensors at an industrial site, a set of detected gas concentration detected by the plurality of sensors, wind velocity at the industrial site, and an identified leakage area at the industrial site. The method also includes iteratively determining locations and leakage rates of one or more leakage sources in the identified leakage area. Each iteration of the iterative determination includes selecting locations and leakage rates of one or more potential leakage sources in the identified leakage area; calculating a set of estimated gas concentrations at the first set of locations of the plurality of sensors by a predictive dispersion model. The predictive dispersion model is configured to receive the wind velocity at the industrial site and the locations and leakage rates of the one or more potential leakage sources as input and generate the set of estimated gas concentration as output. Each iteration also includes comparing the set of estimated gas concentrations with the set of detected gas concentrations. The comparing includes calculating a comparative metric based on the set of estimated gas concentrations and the detected gas concentrations. The method further includes providing the selected location and leakage rates of the potential leakage sources in a current iteration of the iterative determination.

One or more of the following features can be included in any feasible combination.

In some implementations, the method further includes determining that the comparative metric is below a threshold value; and exiting the current iteration of the iterative determination. In some implementations, the method further includes determining that the comparative metric is above a threshold value and performing a new iteration of the iterative determination. The new iteration includes selecting new locations and new leakage rates of one or more potential leakage sources in the identified leakage area and calculating a new set of estimated gas concentration at the first set of locations of the plurality of sensors by the predictive dispersion model. The predictive dispersion model is configured to receive the wind velocity at the industrial site and the new locations and new leakage rates of the one or more potential leakage sources as input and generate the new set of estimated gas concentration as output. The method also includes comparing the new set of estimated gas concentrations with the set of detected gas concentrations. The comparing includes calculating a new comparative metric based on the new set of estimated gas concentrations and the detected gas concentrations.

In some implementations, the method further includes determining the identified leakage area. The determining includes dividing the industrial site into a plurality of voxels; identifying a plurality of source locations in the plurality of voxels. Each voxel of the plurality of voxels includes a source location of the plurality of source locations. The determining also includes estimating a plurality of leakage rates associated with the plurality of source locations based on the prediction model. The prediction model is configured to receive the wind velocity at the industrial site and the set of detected gas concentration as input; and selecting a first voxel of the plurality of voxels based on a first estimated leakage rate associated with a first source location in the first voxel. The identified leakage area includes the first voxel.

In some implementations, selecting the first voxel includes determining that a first estimated leakage rate at the first source location in the first voxel is greater than a localization threshold value. In some implementations, the method further includes determining that a second estimated leakage rate at a second source location in a second voxel of the plurality of voxels is greater than the localization threshold value; and selecting the second voxel, wherein the identified leakage area includes the second voxel. In some implementations, a first voxel of the plurality of voxels is a cube and a first source location of the plurality of source locations associated with the first voxel is at the center of the first voxel.

In some implementations, a first estimated gas concentration associated with a first sensor of the plurality of sensors is calculated in the predictive dispersion model by adding one or more estimated contributions from the one or more potential leakage sources. In some implementations, the first estimated contribution is directly proportional to a product of a first selected leakage rate associated with a first potential leakage source and a propagation function, and inversely proportional to the wind velocity. The propagation function is based on difference between a first location of the first sensor and a selected location of the first potential leakage source. In some implementations, the comparative metric is a L2 norm of a first vector including the estimated gas concentrations and a second vector including detected gas concentrations.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

### DESCRIPTION OF DRAWINGS

These and other features will be more readily understood from the following detailed description taken in conjunction with the accompanying drawings, in which:

FIG. 1 is a flowchart of an exemplary method of determining emission leakage rate associated with one or more sources at an industrial site;

FIG. 2 illustrates a schematic of exemplary gas leak estimation system;

FIGS. 3A-D illustrate exemplary gas concentration profiles of leaked plumes of gas for different wind velocities and leakage rates;

FIG. 4 is an exemplary illustration of concentration profile of a plume of gas as a function of travel distance along the wind direction;

FIG. 5 illustrates an exemplary map of an industrial site that includes multiple source regions;

FIG. 6 illustrates an exemplary map of a source region that has been divided into a plurality of voxels;

FIG. 7 illustrates an exemplary implementation of the leak quantification unit in FIG. 2; and

FIG. 8 illustrates an exemplary computing system 800 configured to determine locations and leakage rates associated with one or more leakage sources.

### DETAILED DESCRIPTION

Industrial sites associated with production and distribution of gas (e.g., methane, carbon di-oxide, hydrogen, etc.) include industrial assets that generate/store gas and networks of pipelines that distribute the gas. The various industrial assets/pipelines can act as an emission source of the gas that may be released into the atmosphere. Operators of the industrial site can monitor and inspect the pipelines and industrial assets to ensure that gases released therefrom (e.g., during failure) do not cause unsafe operating conditions or reduce operating production rates. Operators may also perform monitoring and inspection of the pipelines and industrial assets to ensure that the venting of the gas is occurring in accordance with the expected and normal operational characteristics. Determining the leakage rates from and location of an emission source can be a time-consuming and an error prone process. This process can be further complicated by the presence of prevailing seasonal wind or weather conditions which may distribute the emitted gas in a manner which can make determining the leakage rates challenging. Determination of emission leakage rates may also become challenging due to the presence of multiple emission sources that are distributed over the industrial site (e.g., a large industrial site).

Determination of the emission leakage rates can be improved based on the placement of sensors at the industrial site and location of industrial assets (e.g., which can act as sources of gas leak) in the industrial site. In some implementations of the current subject matter, a user (e.g., an operator) can provide potential locations of the sources and the sensors at the industrial site. For example, the user can provide a map of the industrial site that includes the locations of the industrial assets and/or the network of pipelines that can be possible sources of gas leakage. The map can also identify possible locations where sensors can (or cannot) be placed. Additionally, historical data associated with wind velocity (e.g., wind speed, wind direction, etc.) and leakage rates of the sources can also be provided. Based on this information, the location of the sensors suitable for leak detection at the industrial site or identification of the location of leakage sources can be determined (e.g., based on the map of the industrial site, historical wind velocity data, etc.). Determining the emission leakage rates and locations of the source of leakage (e.g., accurate/fast determination) can improve the response to the gas leakage at the industrial sites (e.g., leaks can be handled in a timely fashion, safety conditions at the industrial sites can be accurately determined, etc.).

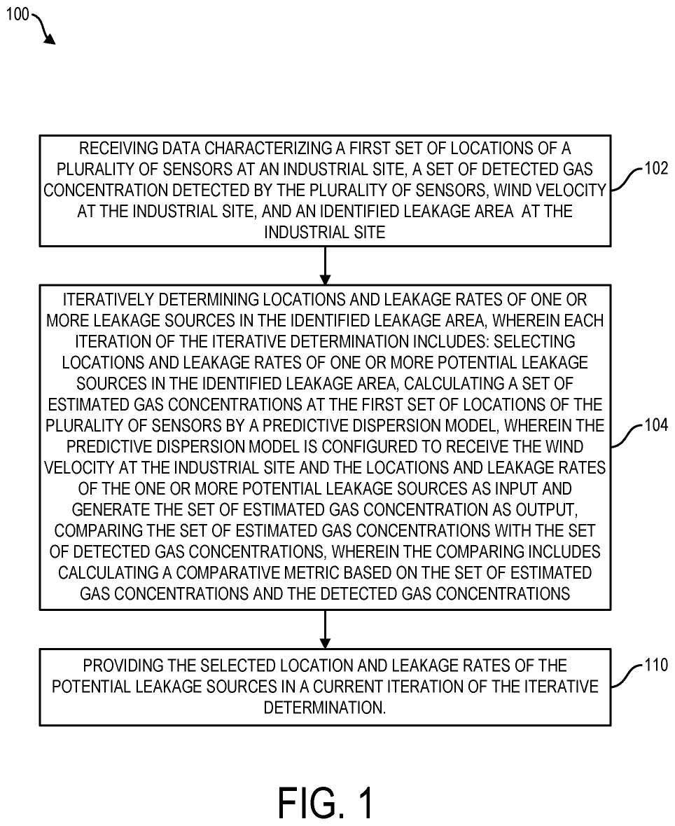

FIG. 1 is a flowchart of an exemplary method 100 of determining emission leakage rate associated with one or more sources at an industrial site. At step 102, data characterizing the locations of sensors (e.g., a first set of locations of a plurality of sensors) at an industrial site and the gas concentration detected by the sensors (e.g., a set of detected gas concentration detected by the plurality of sensors) can be received (e.g., by one or more processors of a computing system associated with the industrial site). The locations of the sensors can be previously determined to improve detection of leaked gas or identification of the locations of sources of gas leak (e.g., based on historical wind velocities and possible location of sources of emission) and the sensors can be installed at the industrial site based on the determined locations. These sensors can detect gas concentration (e.g., at their corresponding location in the industrial site) and relay the detected gas concentration information (e.g., to the computing system associated with the industrial site).

Data characterizing the wind velocity at the industrial site (e.g., current wind velocity, or speed and direction of winds at the time of gas concentration detection) can also be received at step 102. For example, one or more sensors (e.g., anemometer) that can detect wind velocity (e.g., wind speed and direction). In some implementations, if multiple wind velocities are measured, an average of the wind velocities (e.g., average of wind speeds and/or wind directions) can be calculated. Additionally, data characterizing portions (or areas) of industrial site that has been identified as including one or more sources of gas leak (also referred to as identified leakage areas) can be received.

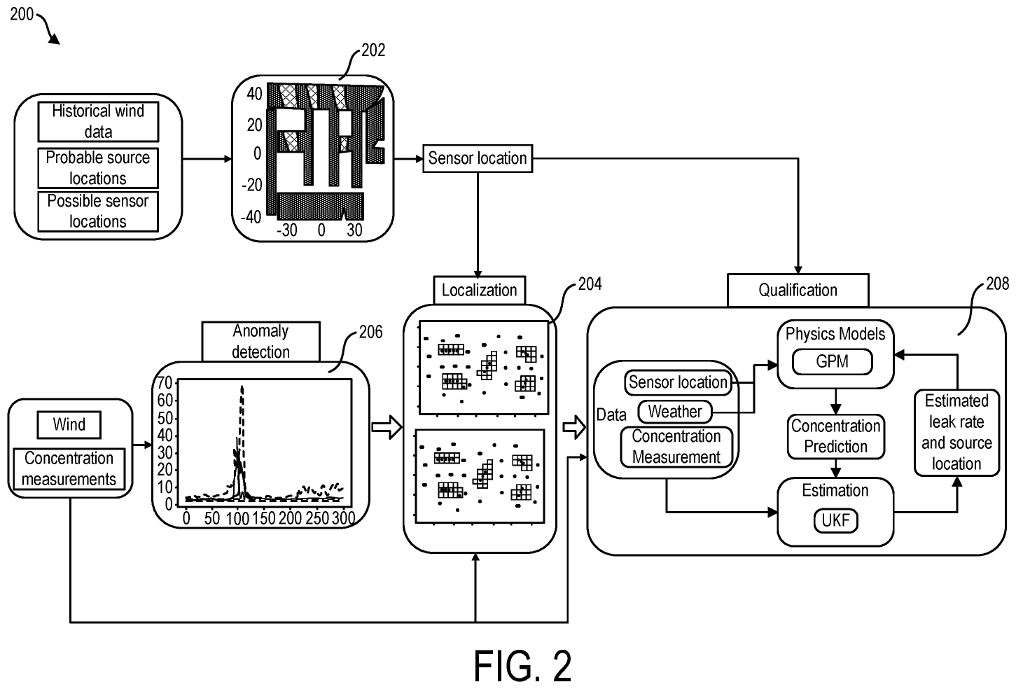

FIG. 2 illustrates a schematic of an exemplary gas leak estimation system 200. The system 200 includes sensor location unit 202, source localization unit 204, anomaly detection unit 206 and leakage quantification unit 208. The sensor localization unit 202 can determine locations of the sensors in the industrial site (e.g., based on historical wind velocity data, probable source locations, possible sensor locations, etc.) and provide the location of the sensors (or sensor location data) to the source localization unit 204 and to the leakage quantification unit 208.

The anomaly detection unit 206 can receive wind velocity data (e.g., current wind velocity data) and the detected gas concentration data detected by the sensors (e.g., corresponding to the time when the wind velocity data was detected) and determine whether the gas concentration detection is anomalous or not. For example, the anomaly detection unit 206 can include a database with a table of wind velocity values and corresponding threshold gas concentration values. The anomaly detection unit 206 can select a threshold gas concentration value from the table (e.g., by identifying a wind velocity value in the table that corresponds to the received wind velocity value and selecting the corresponding threshold gas concentration value). If the detected gas concentration value is greater than the threshold gas concentration value, the detected gas concentration value can be deemed to be anomalous and may not be used by the source localization unit 204 and/or leakage quantification unit 208.

The source localization unit 204 can receive the sensor location data, wind velocity data and gas concentration data (e.g., from the anomaly detection unit 206) and identify leakage area(s) indicative of region(s) in the industrial site where the leakage can occur (or has a high probability of occurring). The leakage quantification unit 208 can receive the sensor location data, the current wind velocity data, the gas concentration data and leakage area(s) data and determine the leakage rates and locations of emission sources.

At step 104, locations and leakage rates of one or more leakage sources (e.g., located in the leakage area identified by the source localization unit 204) can be determined (e.g., by the leakage quantification unit 208). The locations and leakage rates can be detected by an iterative method (e.g., an iterative algorithm) that can employ a prediction dispersion model. In some implementations, the dispersion model can be a Gaussian Plume Model (GPM) described below:

$${C}_{j} ( x , y , z ) = {\sum }_{i = 1}^{N} \frac{{S}_{i}}{2 π U {σ}_{y} ( {x}_{ij} ) {σ}_{z} ( {x}_{ij} )} ( {e}^{- \frac{{y}_{ij}^{2}}{2 {( {σ}_{y} ( {x}_{ij} ) )}^{2}}} ) + [ {e}^{- \frac{{( {z}_{j} - {H}_{i} )}^{2}}{2 {( {σ}_{z} ( {x}_{ij} ) )}^{2}}} + {e}^{- \frac{{( {z}_{j} - {H}_{i} )}^{2}}{2 {( {σ}_{z} ( {x}_{ij} ) )}^{2}}} ]$$

where Cⱼ is an estimation of the gas concentration detected by the j^{th} sensor, Sᵢ is the leakage rate associated with the i^{th} source, U is the wind speed, and xᵢⱼ and yᵢⱼ are the distances between the i^{th} source and j^{th} sensor along the x-direction and y-direction, respectively, zⱼ is the height of the j^{th} sensor and Hi is the height of the i^{th} source. The estimated gas concentration (Cⱼ) (e.g., detected by a sensor of the plurality of sensors) can be a sum of contributions from the various sources in the industrial site. The contribution of a source can be based on the leakage rate (Se) of the source, the speed (U) of the wind velocity and the distance between the sensor and the source along the x-coordinate, y-coordinate and z-coordinate, respectively.

The above-mentioned equation of the Gaussian Plume Model (GPM) can be represented as:

(C)=[A](S)

where (C) is the estimated gas concentration vector that includes various Cⱼ values associated with different sensors in the industrial site; (S) is the leakage rate vector that includes various Sᵢ values associated with different sources in the industrial site; and [A] is a transmission operator that when applied on the leakage rate vector (S) generates the gas concentration vector (C). An element Aⱼᵢ of the transmission operator is given by:

$${A}_{ji} = \frac{1}{2 π U {σ}_{y} ( {x}_{ij} ) {σ}_{z} ( {x}_{ij} )} ( {e}^{- \frac{{y}_{ij}^{2}}{2 {( {σ}_{y} ( {x}_{ij} ) )}^{2}}} ) + [ {e}^{- \frac{{( {z}_{j} - {H}_{i} )}^{2}}{2 {( {σ}_{z} ( {x}_{ij} ) )}^{2}}} + {e}^{- \frac{{( {z}_{j} - {H}_{i} )}^{2}}{2 {( {σ}_{z} ( {x}_{ij} ) )}^{2}}} ]$$

A first estimated gas concentration (e.g., C₁) associated with a first sensor of the plurality of sensors is calculated in the predictive dispersion model by adding estimated contributions from the one or more potential leakage sources (e.g., contribution to gas concentration C₁ from a source with leakage rate Sⱼ can be given by Σᵢ^{N} A₁ᵢSᵢ). The estimated contribution associated with a given source can be directly proportional to a product of the leakage rate (e.g., a first selected leakage rate) associated with the leakage source (e.g., a first potential leakage source) and a propagation function (e.g., exponential portion of the equation above); and inversely proportional to the wind velocity (U). The propagation function is based on difference between the first location of the first sensor and a selected location of the leakage source.

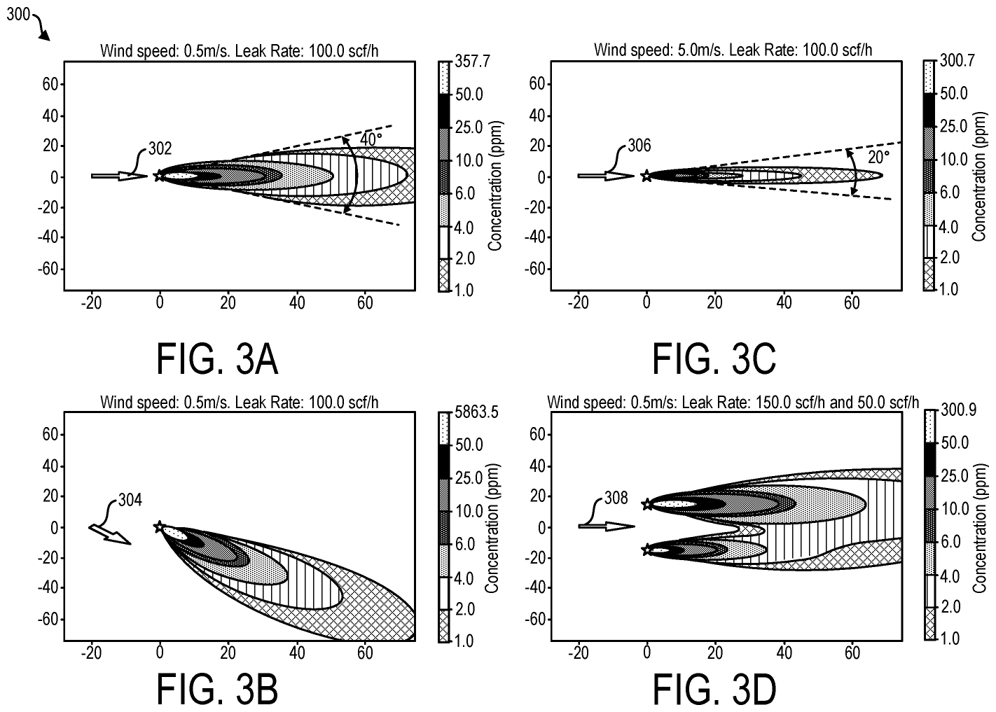

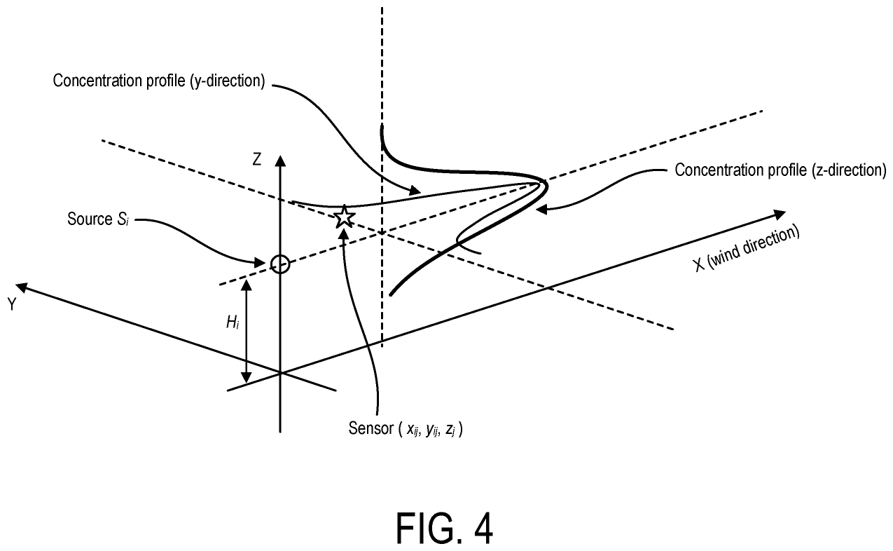

FIGS. 3A-D illustrate exemplary gas concentration profiles of leaked plumes of gas for different wind velocities and leakage rates (Sᵢ) as a function of location at an industrial site (e.g., along x and y directions). FIG. 3A represents the concentration profile associated with a single source having a leakage rate of 100 standard cubic feet/hour (scf/h) and a wind velocity directed along the arrow 302 and having a wind speed of 0.5 meter/sec (m/s). FIG. 3B represents the concentration profile associated with a single source having a leakage rate of 100 scf/h, and a wind velocity directed along the arrow 304 and having a wind speed of 0.5 m/s. FIG. 3C represents the concentration profile associated with a single source having a leakage rate of 100 scf/h, and a wind velocity directed along the arrow 306 and having a wind speed of 5 m/s. FIG. 3D represents the concentration profile associated with a two sources having leakage rates of 150 scf/h and 50 scf/h, respectively; and a wind velocity directed along the arrow 308 and having a wind speed of 0.5 m/s. FIGS. 3A-D indicate that the expansion (or divergence) of a plume of gas leaked by a source at an industrial site decreases with an increase in wind speed (e.g., divergence is 40 degrees for wind speed of 0.5 m/s and divergence is 20 degrees for wind speed of 5 m/s). FIG. 4 is an exemplary illustration of concentration profile of a plume of gas as a function of travel distance along the wind direction.

In some implementations, in each iteration of the iterative method locations of one or more potential leakage sources can be selected (or guessed) in the identified leakage areas (e.g., received at step 102). For example, as described below, the identified leakage area can include multiple voxels that have been identified as including a source with a high probability of leakage. In some implementations, the locations of the leakage sources can be selected from the identified voxels in the leakage areas instead of the entire leakage area. Additionally, the leakage rates associated with the one or more potential leakage sources can be selected (or guessed). The predictive dispersion model is configured to receive various information received at step 102 as an input. For example, the predictive dispersion model can receive as input locations of the sensors (e.g., the first set of locations of a plurality of sensors), gas concentration detected by the sensors (e.g., the set of detected gas concentration) and current wind velocity at the industrial site. The predictive dispersion model can also receive the selected (or guessed) locations and leakage rates of the potential leakage sources in the identified area as input. Based on the aforementioned input, the predictive dispersion model can calculate an estimate for gas concentrations at the location of the various sensors (e.g., the first set of locations of the plurality of sensors) in the industrial site. For example, in the equation of the GPM described above, Sᵢ can represent the selected leakage rates (e.g., each value of i represents a unique selected leakage rate); U represents the current wind velocity; and xᵢⱼ, yᵢⱼ and zᵢⱼ represent the distance between the known sensor locations and the selected source location along the x-axis, y-axis and z-axis.

The estimated gas concentrations generated by predictive dispersion model can be compared with gas concentrations detected by the various sensors (or detected gas concentration) in the industrial site. In some implementations, a comparative metric can be calculated based on the various estimated gas concentrations and the various detected gas concentrations. For example, for each sensor, a difference between the estimated gas concentration associated with the sensor and the gas concentration detected by the sensor can be calculated, and the comparative metric can be calculated based on these differences. In some implementations, the comparative metric can be a L2 norm of a first vector including the estimated gas concentrations associated the various sensors and a second vector gas concentrations detected by the various sensors.

The value of the comparative metric can determine whether another iteration of the iterative determination of locations and leakage rates needs to be performed. For example, if the comparative metric is above a predetermined threshold value, it can be determined that another iteration (e.g., as described in step 104) needs to be performed. In some implementations, a new locations and/or new leakage rates are selected (or guessed) for potential leakage sources in the identified area. The predictive dispersion model can calculate a new estimate for gas concentrations at the location of the various sensors based on the new locations and/or leakage rates along with input locations of the sensors, gas concentration detected by the sensors and current wind velocity at the industrial site. A new comparative metric is calculated (e.g., by comparing the new estimate for gas concentrations with gas concentrations detected by the various sensors) and compared with the predetermined threshold value. In some implementation, this process can be repeated until the comparative metric is less than the predetermined threshold value. For example, if the comparative metric is below the predetermined threshold value, the iterative the current iteration of the iterative determination can be exited (e.g., the iterative determination can stop).

Returning back to FIG. 1, at step 108, selected locations and leakage rates of the potential leakage sources in the current iteration (e.g., the latest iteration) of the iterative determination can be provided. For example, the selected locations and leakage rates can be provided to a user/operator associate with the industrial site. Based on the leakage rates and/or locations of the sources, the user can determine, for example, if the operating conditions are safe in the industrial site, venting of the gas is occurring in accordance with the expected and normal operational characteristics, etc.

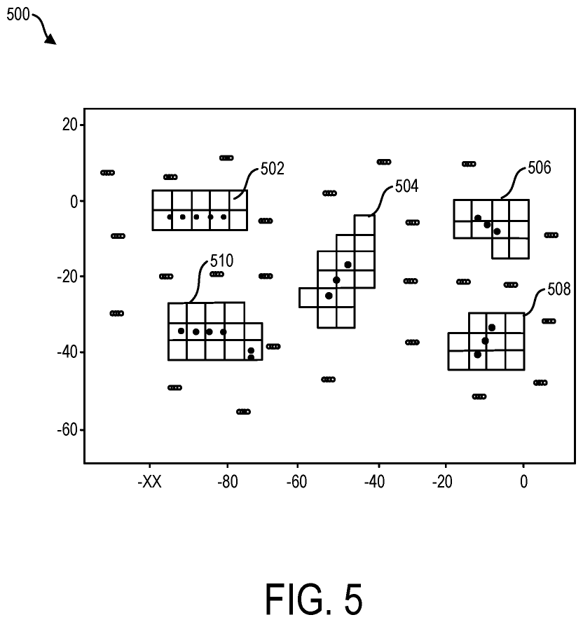

In some implementations, region(s) of the industrial site that include (or are likely to include) the source of gas leak can be identified. This process (also referred to as localization) as described below can be based on current wind velocity detected by anemometer in the industrial site, and detected gas concentration. Identification of regions in the industrial site that include sources can improve the determination of leakage rates (e.g., make the leakage rate determine faster, more accurate, etc.). In some implementations, portions (or areas) of industrial site that include one or more sources of gas leak can be identified (e.g., by the source localization unit 204). This can be done by dividing the industrial site (or source region(s) therein) into a plurality of voxels and identifying source locations in the voxels. FIG. 5 illustrates an exemplary map of an industrial site 500 that includes source regions 502-510 that have been identified as having sources that can leak gas. For example, source regions can overlap with regions in the industrial site that include industrial assets (e.g., pipes, industrial assets, etc., that can leak gas) that can leak gas. As discussed above, a user (or operator) can identify the source regions of the industrial site (e.g., by providing a map that includes information associated with the locations of the pipes/industrial assets).

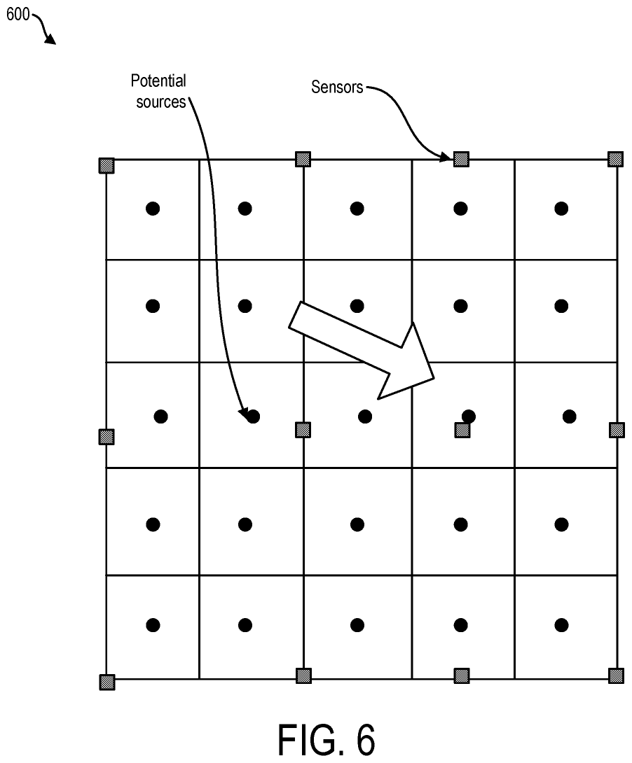

FIG. 6 illustrates an exemplary map of a source region 600 that has been divided into a plurality of voxels and a source location can be identified in each voxel of the plurality of voxels. In other words, a plurality of source locations can be identified. For example, it can be assumed that the source is located in the center of the voxel (e.g., if the voxel is a cube, the center can be at the intersection of the diagonals of the cube). Based on the guessed locations of the plurality of sources in the various voxels, leakage rates associated with the various sources can be estimated using the iterative method that includes the predictive dispersion model (e.g., as described above). For example, in each iteration of the iterative model leakage rates associated with the various sources identified above (that are located at the center of the voxels) can be selected (or guessed). The predictive dispersion model can calculate an estimate for gas concentrations at the location of the various sensors (e.g., the first set of locations of the plurality of sensors) in the industrial site based on the guessed locations of the plurality of sources (e.g., located at the center of the voxels), current wind velocity, the selected (or guessed) leakage rate associated with each the plurality of sources, and locations of the sensors. The estimated gas concentrations can be compared with the detected gas concentrations by the sensors (e.g., as described above) and a comparative metric can be calculated for each iteration. The comparative metric can be compared with a predetermined threshold value, and a determination is made to exit the iterative process (e.g., when the comparative metric is below the predetermined threshold value) or perform a new iteration (e.g., when the comparative metric is above the predetermined threshold value).

After an estimated leakage rate has been calculated for the various voxels in the plurality of voxels in the industrial site, the voxels can be ranked based on the corresponding value of the estimated leakage rate. In some implementations, voxels can be identified as having a high probability of leaking (e.g., if the corresponding estimated leakage rate is above a first localized threshold leakage rate), a medium probability of leaking (e.g., if the corresponding estimated leakage rate is below the first localized threshold leakage rate and above a second first localized threshold leakage rate) and a small probability of leaking (e.g., if the corresponding estimated leakage rate is below the second localized threshold leakage rate). In some implementations, adjacent voxels can be clustered together prior to the above-mentioned ranking.

In some implementations, one or more voxels can be selected based on their estimated threshold value. For example, a first voxel of the plurality of voxels can be selected based on a first estimated leakage rate associated with a first source location in the first voxel. The selection of the first voxel can include determining that the first estimated leakage rate at the first source location is greater than a localization threshold leakage rate value. In some implementations, all the voxels that have been identified as having a certain probability of leaking (e.g., high probability, medium probability, low probability, or a combination thereof) can be selected. The selected voxels can be included in the identified leakage areas (received by the leakage quantification unit 208 at step 102).

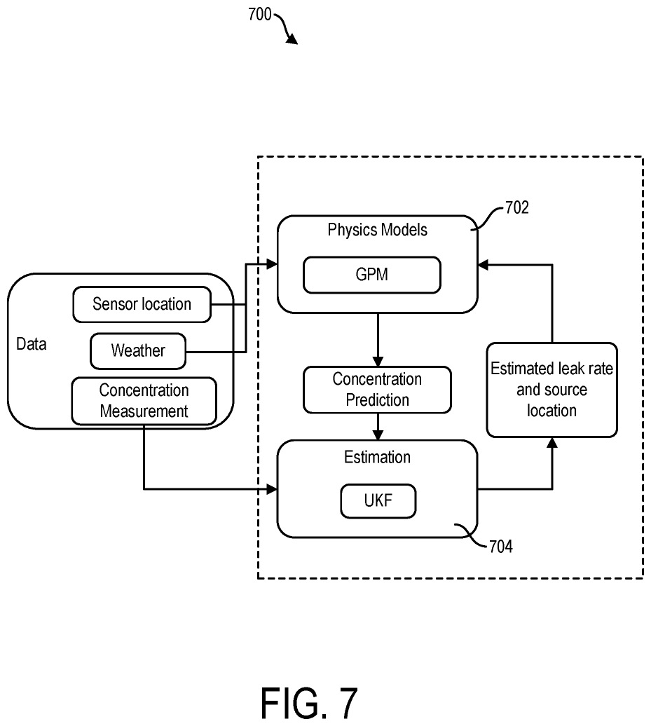

FIG. 7 illustrates an exemplary implementation 700 of the leakage quantification unit 208. The implementation 700 includes a predictive dispersion model 702 and an estimation unit 704. The implementation 700 can receive sensor location data (e.g., from sensor location unit 202), current wind velocity data (e.g., from anemometer(s) in the industrial site), detected gas concentration data (e.g., from the sensors in the industrial site, from the anomaly detection unit 206, etc.), and identified leakage areas (e.g., from the source localization unit 204). The predictive dispersion model 702 can determine an estimated gas concentration at the sensor locations. The estimation unit 704 can determine the accuracy of the estimated gas concentration (e.g., by comparing with detected gas concentration), and select (or guess) new values for source locations and leakage rates and provide them to the predictive dispersion model 702. This process can continue until the estimated gas concentration is below a predetermined threshold value.

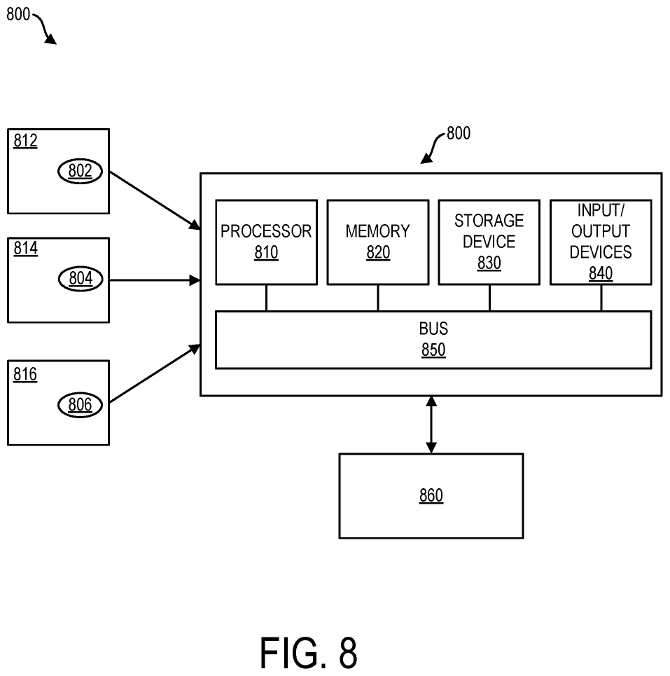

FIG. 8 illustrates an exemplary computing system 800 configured to determine locations and leakage rates associated with one or more leakage sources (e.g., by executing the exemplary method 100). The computing system 800 can receive data characterizing the locations of sensors, and the gas concentration detected by the sensors 802, 804 and 806 positioned in the industrial site at locations 812, 814 and 816, respectively. The computing system 800 can include a processor 810, a memory 820, a storage device 830, and input/output devices 840. The processor 810, the memory 820, the storage device 830, and the input/output devices 840 can be interconnected via a system bus 850. The processor 810 is capable of processing instructions for execution within the computing system 800. Such executed instructions can implement one or more components of, for example, the data communication system, the reconfiguration system, and the like. In some example embodiments, the processor 810 can be a single-threaded processor. Alternately, the processor 810 can be a multi-threaded processor. The processor 810 is capable of processing instructions stored in the memory 820 and/or on the storage device 830 to display graphical information for a user interface provided via the input/output device 840.

The memory 820 is a computer readable medium such as volatile or non-volatile that stores information within the computing system 800. The memory 820 can store data structures representing configuration object databases, for example. The storage device 830 is capable of providing persistent storage for the computing system 800. The storage device 830 can be a floppy disk device, a hard disk device, an optical disk device, a tape device, a solid state drive, and/or other suitable persistent storage means. The input/output device 840 provides input/output operations for the computing system 800. In some implementations, data characterizing the segregator code, the aggregator code, the plurality of configuration parameters, etc., can be received by the computing system 800 (e.g., from an user computing device 860). In some example embodiments, the input/output device 840 includes a keyboard and/or pointing device. In various implementations, the input/output device 840 includes a display unit for displaying graphical user interfaces.

Some exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., a GPU (graphical processing unit), an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A method comprising:
receiving data characterizing a first set of locations of a plurality of sensors at an industrial site, a set of detected gas concentration detected by the plurality of sensors, wind velocity at the industrial site, and an identified leakage area at the industrial site;
iteratively determining locations and leakage rates of one or more leakage sources in the identified leakage area, wherein each iteration of the iterative determination comprises:
selecting locations and leakage rates of one or more potential leakage sources in the identified leakage area,
calculating a set of estimated gas concentrations at the first set of locations of the plurality of sensors by a predictive dispersion model, wherein the predictive dispersion model is configured to receive the wind velocity at the industrial site and the locations and leakage rates of the one or more potential leakage sources as input and generate the set of estimated gas concentration as output,
comparing the set of estimated gas concentrations with the set of detected gas concentrations, wherein the comparing comprises calculating a comparative metric based on the set of estimated gas concentrations and the detected gas concentrations; and
providing the selected location and leakage rates of the potential leakage sources in a current iteration of the iterative determination.

2. The method of claim 1, further comprising
determining that the comparative metric is below a threshold value; and
exiting the current iteration of the iterative determination.

3. The method of claim 1, further comprising:
determining that the comparative metric is above a threshold value; and
performing a new iteration of the iterative determination, wherein the new iteration comprises:
selecting new locations and new leakage rates of one or more potential leakage sources in the identified leakage area,
calculating a new set of estimated gas concentration at the first set of locations of the plurality of sensors by the predictive dispersion model, wherein the predictive dispersion model is configured to receive the wind velocity at the industrial site and the new locations and new leakage rates of the one or more potential leakage sources as input and generate the new set of estimated gas concentration as output,
comparing the new set of estimated gas concentrations with the set of detected gas concentrations, wherein the comparing comprises calculating a new comparative metric based on the new set of estimated gas concentrations and the detected gas concentrations.

4. The method of claim 1, further comprises determining the identified leakage area, wherein the determining comprises:
dividing the industrial site into a plurality of voxels;
identifying a plurality of source locations in the plurality of voxels, wherein each voxel of the plurality of voxels comprises a source location of the plurality of source locations;
estimating a plurality of leakage rates associated with the plurality of source locations based on the prediction model, wherein the prediction model is configured to receive the wind velocity at the industrial site and the set of detected gas concentration as input; and
selecting a first voxel of the plurality of voxels based on a first estimated leakage rate associated with a first source location in the first voxel, wherein the identified leakage area comprises the first voxel.

5. The method of claim 4, wherein selecting the first voxel comprises determining that a first estimated leakage rate at the first source location in the first voxel is greater than a localization threshold value.

6. The method of claim 5, further comprising:
determining that a second estimated leakage rate at a second source location in a second voxel of the plurality of voxels is greater than the localization threshold value; and
selecting the second voxel, wherein the identified leakage area comprises the second voxel.

7. The method of claim 4, wherein a first voxel of the plurality of voxels is a cube and a first source location of the plurality of source locations associated with the first voxel is at the center of the first voxel.

8. The method of claim 1, wherein a first estimated gas concentration associated with a first sensor of the plurality of sensors is calculated in the predictive dispersion model by adding one or more estimated contributions from the one or more potential leakage sources.

9. The method of claim 8, wherein a first estimated contribution of the one or more estimated contributions is directly proportional to a product of a first selected leakage rate associated with a first potential leakage source and a propagation function, and inversely proportional to the wind velocity,
wherein the propagation function is based on difference between the first location of the first sensor and a selected location of the first potential leakage source.

10. The method of claim 1, wherein the comparative metric is a L2 norm of a first vector including the estimated gas concentrations and a second vector including detected gas concentrations.
